(19) United States
(12) Patent Application Publication
(10) Pub. No.: US 2013/0146684 A1
(43) Pub. Date: Jun. 13, 2013

(54) ELECTROSTATIC SPRAYER

(71) Applicants: Kouichi Minakuchi, Shiga (JP); Aoi Shinohara, Shiga (JP); Tomohiko Tsutsumi, Shiga (JP); Natsumi Yukawa, Shiga (JP); Akira Nagamori, Shiga (JP); Satoshi Kishimoto, Osaka (JP); Makoto Ide, Shiga (JP); Kouei Obata, Osaka (JP); Mamoru Okumoto, Osaka (JP); Masashi Kamada, Osaka (JP)

(72) Inventors: Kouichi Minakuchi, Shiga (JP); Aoi Shinohara, Shiga (JP); Tomohiko Tsutsumi, Shiga (JP); Natsumi Yukawa, Shiga (JP); Akira Nagamori, Shiga (JP); Satoshi Kishimoto, Osaka (JP); Makoto Ide, Shiga (JP); Kouei Obata, Osaka (JP); Mamoru Okumoto, Osaka (JP); Masashi Kamada, Osaka (JP)

(73) Assignee: DAIKIN INDUSTRIES, LTD., Osaka-shi, Osaka (JP)

(21) Appl. No.: 13/818,543

(22) PCT Filed: Aug. 31, 2011
(86) PCT No.: PCT/JP2011/004886

§ 371 Date: Feb. 22, 2013

(30) Foreign Application Priority Data
Aug. 31, 2010 (JP) 2010-194721
Oct. 20, 2010 (JP) 2010-235869

(51) Int. Cl. B05B 5/00

(52) U.S. Cl. CPC B05B 5/00
USPC 239/690

(57) ABSTRACT

An electrostatic sprayer includes a temperature-humidity sensor which detects a humidity and a temperature of a space where the user is present, and a control section which provides control by adjusting an amount of the liquid transferred by a pressure pump and a voltage applied by a high voltage power supply based on the value detected by the temperature-humidity sensor.

### TECHNICAL FIELD

The present invention relates to electrostatic sprayers, and specifically relates to operational control of the electrostatic sprayers.

### BACKGROUND ART

Liquid sprayers which spray liquid stored in a container have been known. The liquid sprayers include an electrostatic sprayer which, as shown in Patent Document 1, sprays charged liquid to a user by utilizing an electric field generated at a tip (a discharge end) of a nozzle.

The electrostatic sprayer shown in Patent Document 1 transfers the liquid in a bag-like container to the discharge end of the nozzle by compressing the bag-like container. If a high voltage is applied in this state to the liquid at the discharge end of the nozzle, an electric field is generated between the discharge end of the nozzle and a counter electrode. As a result, the liquid charged at the discharge end of the nozzle is pulled apart into sprayed particles, and these sprayed particles are diffused. The diffused sprayed particles are supplied to an object. In Patent Document 1, the sprayed particles are a lotion and applied to the face, etc., of the user as an object.

### Citation List

### Patent Document

Patent Document 1: Japanese Patent Publication No. 2009-022891

### SUMMARY OF THE INVENTION

### Technical Problem

The time until the tank is empty becomes shorter with an increase in time of continuous operation of the electrostatic sprayer. If the time until the tank is empty is excessively short, the user has to remove the tank frequently, provided the tank is a cartridge type. If the tank is not a cartridge type, the user has to refill the tank with a liquid frequently. Accordingly, if the continuous operation time of the electrostatic sprayer increases, the user has to perform maintenance more frequently to prevent the tank from being empty.

The present invention is thus intended to reduce maintenance procedures for an electrostatic sprayer which are necessary to prevent a tank from being empty, thereby achieving comfortable use of the electrostatic sprayer by a user.

### Solution to the Problem

The first aspect of the present invention is directed to an electrostatic sprayer, including: a container (71) which stores a liquid; a nozzle (72) which connects an inside and an outside of the container (71); a transfer section (41) which transfers the liquid in the container (71) to a discharge end (72c) of the nozzle (72); a counter electrode (12) located near the discharge end (72c) of the nozzle (72); and a voltage applying section (50) which applies a voltage to the liquid in the container (71) to generate an electric field between the liquid transferred to the discharge end (72c) of the nozzle (72) by the transfer section (41) and the counter electrode (12), for spraying the liquid flowing out of the discharge end (72c) of the nozzle (72) to a user.

The above electrostatic sprayer includes a detecting section (29) which detects at least a temperature of a space where the user is present, and a control section (3) which adjusts at least one of an amount of the liquid transferred by the transfer section (41) or a voltage applied by the voltage applying section (50) according to a value detected by the detecting section (29).

In the first aspect of the present invention, an amount of the liquid transferred to the discharge end (72c) of the nozzle (72) and a voltage applied to the liquid in the container (71) are adjusted when necessary, according to the value (the temperature) detected by the detecting section (29). By adjusting the transfer amount of the liquid, the amount of liquid supplied to the discharge end (72c) of the nozzle (72) from the container (71) is adjusted. By adjusting the voltage applied to the liquid, the magnitude of the electric field generated near the discharge end (72c) of the nozzle (72) is adjusted. Accordingly, it is possible to adjust the spray amount of the electrostatic sprayer (1).

The second aspect of the present invention is directed to an electrostatic sprayer, including: a container (71) which stores a liquid; a nozzle (72) which connects an inside and an outside of the container (71); a transfer section (41) which transfers the liquid in the container (71) to a discharge end (72c) of the nozzle (72); a counter electrode (12) located near the discharge end (72c) of the nozzle (72); and a voltage applying section (50) which applies a voltage to the liquid in the container (71) to generate an electric field between the liquid transferred to the discharge end (72c) of the nozzle (72) by the transfer section (41) and the counter electrode (12), for spraying the liquid flowing out of the discharge end (72c) of the nozzle (72) to a user.

The above electrostatic sprayer includes a detecting section (29) which detects at least a humidity of a space where the user is present, and a control section (3) which adjusts at least one of an amount of the liquid transferred by the transfer section (41) or a voltage applied by the voltage applying section (50) according to a value detected by the detecting section (29).

In the second aspect of the present invention, an amount of the liquid transferred to the discharge end (72c) of the nozzle (72) and a voltage applied to the liquid in the container (71) are adjusted when necessary, according to the value (the humidity) detected by the detecting section (29). By adjusting the transfer amount of the liquid, the amount of liquid supplied to the discharge end (72c) of the nozzle (72) from the container (71) is adjusted. By adjusting the voltage applied to the liquid, the magnitude of the electric field generated near the discharge end (72c) of the nozzle (72) is adjusted. Accordingly, it is possible to adjust the spray amount of the electrostatic sprayer (1).

The third aspect of the present invention is that in the first or second aspect of the present invention, the detecting section (29) detects a temperature and a humidity of the space where the user is present.

In the third aspect of the present invention, the amount of the liquid transferred to the discharge end (72c) of the nozzle (72) and the voltage applied to the liquid in the container (71) are adjusted when necessary, according to the temperature and the humidity as a value detected by the detecting section (29).

The fourth aspect of the present invention is that in the first or third aspect of the present invention, the control section (3) stops operations of the transfer section (41) and the voltage applying section (50) when the value detected by the detecting section (29) is changed from a range where the user is expected to feel comfortable at least under a temperature condition to a range where the user is expected to feel uncomfortable at least under a temperature condition.

In the fourth aspect of the present invention, it is decided whether the space where the user is present is in an uncomfortable state or not, based on the value (the temperature) detected by the detecting section (29). If it is decided that the space where the user is present is in an uncomfortable state, operations of the transfer section (41) and the voltage applying section (50) are stopped because the user may not be able to easily feel the effect of the liquid spraying. Thus, the liquid spraying of the electrostatic sprayer (1) is stopped.

The fifth aspect of the present invention is that in the second or third aspect of the present invention, the control section (3) stops operations of the transfer section (41) and the voltage applying section (50) when the value detected by the detecting section (29) is changed from a range where the user is expected to feel comfortable at least under a humidity condition to a range where the user is expected to feel uncomfortable at least under a humidity condition.

In the fifth aspect of the present invention, it is decided whether the space where the user is present is in an uncomfortable state or not, based on the value (the humidity) detected by the detecting section (29). If it is decided that the space where the user is present is in an uncomfortable state, operations of the transfer section (41) and the voltage applying section (50) are stopped because the user may not be able to easily feel the effect of the liquid spraying. Thus, the liquid spraying of the electrostatic sprayer (1) is stopped.

The sixth aspect of the present invention is that in the fourth or fifth aspect of the present invention, the control section (3) stops the operation of the transfer section (41), and thereafter stops the operation of the voltage applying section (50).

In the sixth aspect of the present invention, the liquid is not transferred to the discharge end (72c) of the nozzle (72) without an electric field generated at the discharge end (72c) of the nozzle (72).

The seventh aspect of the present invention is that in the first or third aspect of the present invention, the control section (3) starts operations of the transfer section (41) and the voltage applying section (50) when the value detected by the detecting section (29) is changed from a range where the user is expected to feel uncomfortable at least under a temperature condition to a range where the user is expected to feel comfortable at least under a temperature condition.

In the seventh aspect of the present invention, operations of the transfer section (41) and the voltage applying section (50) are started if it is decided that the space where the user is present is in a comfortable state, because the user can easily feel the effect of the liquid spraying. Thus, the liquid spraying of the electrostatic sprayer (1) is started.

The eighth aspect of the present invention is that in the second or third aspect of the present invention, the control section (3) starts operations of the transfer section (41) and the voltage applying section (50) when the value detected by the detecting section (29) is changed from a range where the user is expected to feel uncomfortable at least under a humidity condition to a range where the user is expected to feel comfortable at least under a humidity condition.

In the eighth aspect of the present invention, operations of the transfer section (41) and the voltage applying section (50) are started if it is decided that the space where the user is present is in a comfortable state, because the user can easily feel the effect of the liquid spraying. Thus, the liquid spraying of the electrostatic sprayer (1) is started.

The ninth aspect of the present invention is that in the seventh or the eighth aspect of the present invention, the control section (3) starts the operation of the voltage applying section (50), and thereafter starts the operation of the transfer section (41).

In the ninth aspect of the present invention, similar to the sixth aspect of the present invention, the liquid is not transferred to the discharge end (72c) of the nozzle (72) without an electric field generated at the discharge end (72c) of the nozzle (72).

The tenth aspect of the present invention is that in the second or third aspect of the present invention, the electrostatic sprayer includes an insulating material (10) which provides insulation between the liquid in the container (71) and the counter electrode (12); the detecting section (29) is a space facing the insulating material (10), and is configured to detect the humidity of the space where the user is present; and the control section (3) is configured to reduce the voltage applied by the voltage applying section (50) when a humidity value as the value detected by the detecting section (29) increases.

In the tenth aspect of the present invention, if the humidity of the space where the user is present is high, the voltage V applied from the voltage applying section (50) is reduced. This is done because a potential of the insulating material (10) decreases if the humidity of the space where the user is present is increased, and an excessive voltage may be applied if the voltage V is not reduced, and this may result in difficulties in spraying the liquid like a thread from the nozzle (72).

The eleventh aspect of the present invention is that in the second or third aspect of the present invention, the electrostatic sprayer includes an insulating material (10) which provides insulation between the liquid in the container (71) and the counter electrode (12); the detecting section (29) is a space facing the insulating material (10), and is configured to detect the humidity of the space where the user is present; and the control section (3) is configured to increase the voltage applied by the voltage applying section (50) when a humidity value as the value detected by the detecting section (29) decreases.

In the eleventh aspect of the present invention, if the humidity of the space where the user is present is low, the voltage V applied from the voltage applying section (50) is increased. This is done because a potential of the insulating material (10) increases if the humidity of the space where the user is present is reduced, and undervoltage may occur if the voltage V is not increased, and this may result in difficulties in spraying the liquid like a thread from the nozzle (72).

The twelfth aspect of the present invention is that in the first or third aspect of the present invention, the control section (3) includes in advance a table or a function which specifies a correspondence relationship between the value detected by the detecting section (29) and a spray amount of the liquid based on a dry skin condition, and adjusts at least one of the amount of the liquid transferred by the transfer section (41) or the voltage applied by the voltage applying section (50) according to the table or the function.

In the twelfth aspect of the present invention, a table or a function is stored in the control section (3). The table or the function specifies a correspondence relationship between the temperature or the temperature and humidity of the space where the user is present and a spray amount, based on dry skin condition. In the control section (3), a spray amount corresponding to the temperature or the temperature and humidity of the surroundings is determined based on the table or the function. At least one of the amount of the liquid transferred by the transfer section (41) or the voltage applied from the voltage applying section (50) is adjusted so that the determined amount of the liquid will be sprayed. Since the spray amount is adjusted according to the table or the function in which spray amounts necessary for skin moisturization are categorized, it is possible to provide skin moisture control corresponding to dry skin condition with more reliability.

### Advantages of the Invention

According to the present invention, the amount of liquid sprayed by the electrostatic sprayer can be adjusted based on a value (the temperature and the humidity) detected by the detecting section (29). Thus, the spray amount can be optimized and saved, according to the space where the user is present. As a result, it is possible to delay the time when the tank (71) becomes empty, and reduce the number of maintenance procedures for preventing the tank (71) from becoming empty.

Further, the electrostatic sprayer of the present invention can provide skin moisture control in which it is necessary to adjust the spray amount according to the temperature of the space where the user is present.

Specifically, according to the third aspect of the present invention, the spray amount is adjusted according to the humidity, in addition to according to the temperature. Thus, the spray amount can be further optimized, and as a result, it is possible to further delay the time when the container (71) becomes empty. By including, as a setting condition, the humidity which affects dry skin next to the temperature, it is possible for the electrostatic sprayer to determine the spray amount necessary for skin moisturization in more detail, and control skin moisture with more accuracy.

According to the fourth and fifth aspects of the present invention, liquid spraying of the electrostatic sprayer is stopped if it is decided that the space where the user is present is in an uncomfortable state, because in such a state the user may not be able to easily feel the effect of the liquid spraying. Thus, wasteful spraying of the liquid is reduced, and the number of maintenance procedures for preventing the container (71) from becoming empty can be reduced than before. Due to the reduction in the number of maintenance procedures, the user can use the electrostatic sprayer comfortably.

According to the sixth aspect of the present invention, it is possible to prevent the liquid from being transferred to the discharge end (72c) of the nozzle (72) without an electric field generated at the discharge end (72c) of the nozzle (72). As a result, a leak of the liquid from the discharge end (72c) of the nozzle (72) can be prevented.

According to the seventh and eighth aspects of the present invention, liquid spraying of the electrostatic sprayer is started if it is decided that the space where the user is present is in a comfortable state, because in such a state the user can easily feel the effect of the liquid spraying. Thus, the electrostatic sprayer can be effectively operated.

According to the ninth aspect of the present invention, similar to the sixth aspect of the present invention, it is possible to prevent the liquid from being transferred to the discharge end (72c) of the nozzle (72) without an electric field generated at the discharge end (72c) of the nozzle (72). As a result, a leak of the liquid from the discharge end (72c) of the nozzle (72) can be prevented.

According to the tenth aspect of the present invention, if the humidity of the space where the user is present is high, the voltage V applied from the applying section (50) is reduced so that the liquid can be easily sprayed like a thread from the nozzle (72). Thus, the state of spraying the liquid from the electrostatic sprayer can be stabilized even if the humidity of the space where the user is present is increased.

According to the eleventh aspect of the present invention, if the humidity of the space where the user is present is low, the voltage V applied from the voltage applying section (50) is increased so that the liquid can be easily sprayed like a thread from the nozzle (72). Thus, the state of spraying the liquid from the electrostatic sprayer can be stabilized even if the humidity of the space where the user is present is reduced.

### BRIEF DESCRIPTION OF THE DRAWINGS

FIG. 1 is an oblique view showing an entire electrostatic sprayer according to an embodiment.

FIG. 2 is a longitudinal cross-section of the electrostatic sprayer according to the embodiment.

FIG. 3 shows a system configuration of the electrostatic sprayer according to the embodiment.

FIG. 4 is an oblique view showing an upper portion of the electrostatic sprayer according to the embodiment.

FIG. 5 shows an internal structure of a top cover of the electrostatic sprayer according to the embodiment.

FIG. 6 is an oblique view showing an internal structure of the electrostatic sprayer according to the embodiment.

FIG. 7 shows a configuration of a transfer unit according to the embodiment.

FIG. 8 is a longitudinal cross-section showing a spray cartridge according to the embodiment.

FIG. 9 is a front view of the spray cartridge according to the embodiment.

FIG. 10 is a temperature-humidity graph relating to an operation mode and a stand-by mode of the electrostatic sprayer according to the embodiment.

FIG. 11 is a time chart of the electrostatic sprayer according to the embodiment.

FIG. 12 is a flow chart of a control section of the electrostatic sprayer according to the embodiment.

FIG. 13 is a table showing a correspondence relationship between the temperature and the spray amount according to the first variation of the embodiment.

FIG. 14 is a flow chart of control of a control section according to the first variation of the embodiment.

FIG. 15 is a table showing a correspondence relationship between the temperature, the humidity, and the spray amount according to the second variation of the embodiment.

### DESCRIPTION OF EMBODIMENTS

Embodiments of the present invention will be described in detail below based on the drawings.

An electrostatic sprayer (1) according to the present embodiment is configured to spray water or a liquid containing hyaluronic acid, etc. to the user. The electrostatic sprayer (1) will be described first, and a controller (2) which controls operation of the electrostatic sprayer (1) will be described thereafter.

### Electrostatic Sprayer

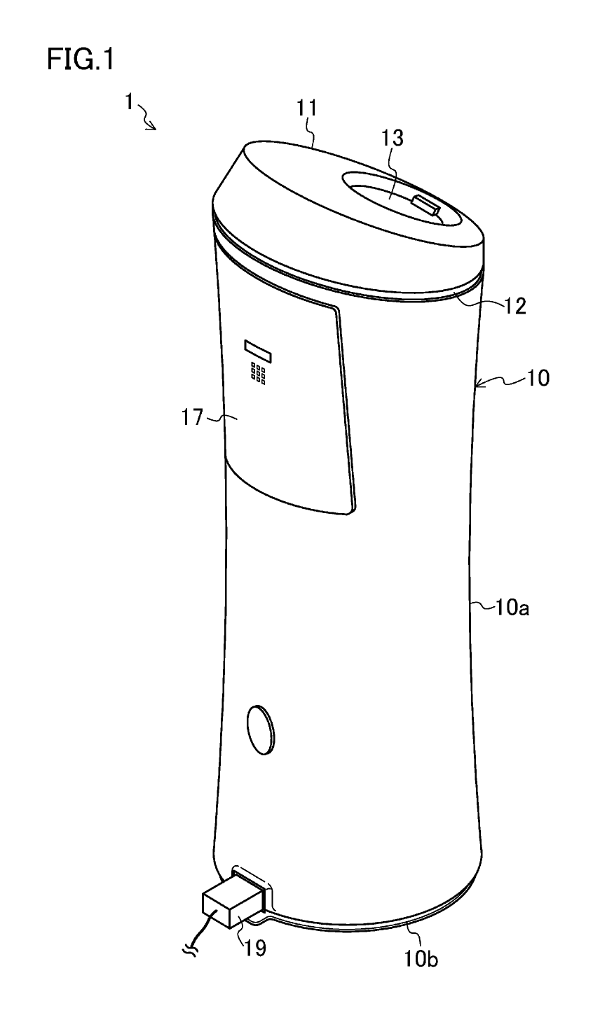

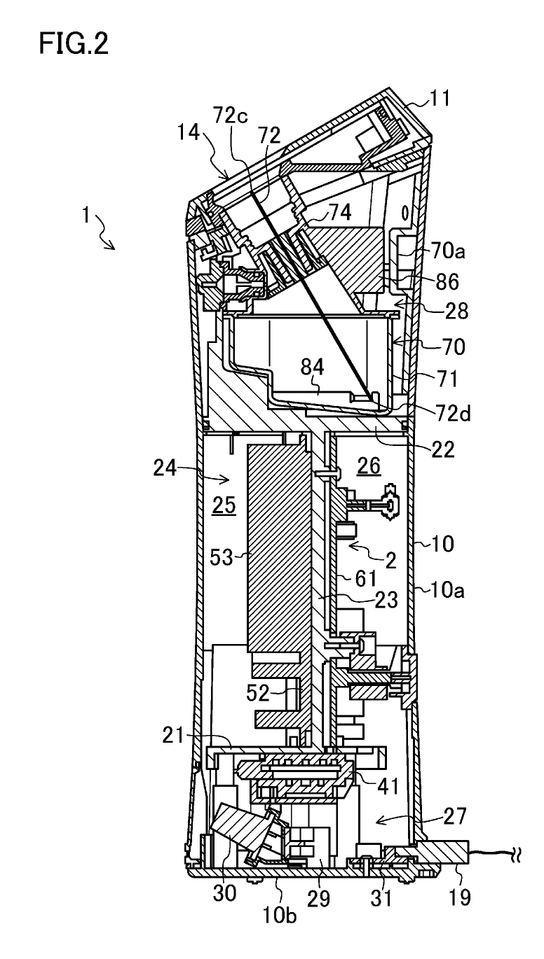

The electrostatic sprayer (1) includes, as shown in FIG. 1 to FIG. 3, a casing (10), a spray cartridge (70) attachable to and detachable from the casing (10), a transfer unit (40) housed in the casing (10), a high voltage power supply (a voltage applying section) (50) which applies an voltage to a liquid, and an adapter (18) as a power supply.

The casing (10) is a vertically-oriented cylindrical member having a closed end. The casing (10) is comprised of a designed cover (10a), a bottom cover (10b), and a top cover (11). In the present embodiment, the liquid is sprayed toward a front side, and the direction opposite the spraying direction is a back side.

The designed cover (10a) is in a tubular shape and forms a side portion of the casing (10). The designed cover (10a) has an upper and lower open ends. The bottom cover (10b) is for closing the lower open end of the casing (10).

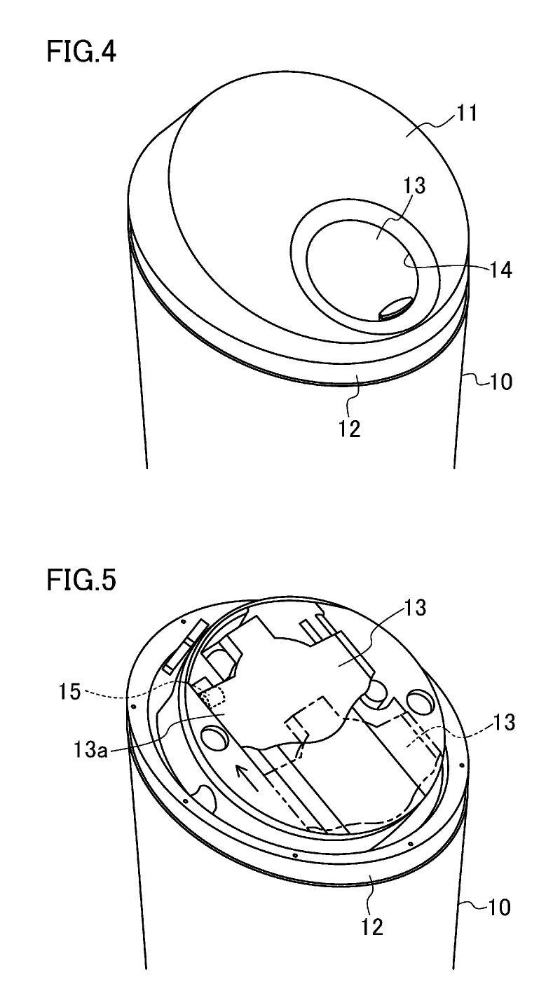

The top cover (11) is for closing the open end at the upper portion of the designed cover (10a). The upper surface of the top cover (11) is tilted obliquely downward from the back side to the front side, as shown in FIG. 4. The top cover (11) is provided with a spray opening (14) for exposing the nozzle (72) of the spray cartridge (70) on its generally front side. A slidable shutter (13) is attached to the edge portion of the spray opening (14). As shown in FIG. 5, the shutter (13) is configured to be closed when it is slid toward the front side, and open when it is slid toward the back side.

The top cover (11) is also provided with an operation switch (15) configured to turn ON/OFF of the spraying operation. The operation switch (15) is turned ON when the shutter (13) is moved to the back side (to the shutter (13) opening direction) and a side portion (13a) of the shutter (13) pushes down the operation switch (15). That is, the shutter (13) serves as a pusher which turns ON/OFF of the operation switch (15). When the operation switch (15) is ON, a controller (2) described later makes the electrostatic sprayer (1) start spraying. The shutter (13) having been moved to the back side is energized by a spring (not shown) from below and is held by the top cover (11).

On the other hand, the operation switch (15) is turned OFF when the shutter (13) is moved to the front side (to the shutter (13) closing direction) and the side portion (13a) of the shutter (13) separates from the operation switch (15). When the operation switch (15) is OFF, the controller (2) stops the spraying operation of the electrostatic sprayer (1). That is, the electrostatic sprayer (1) of the present embodiment is configured to be able to control ON/OFF of the spraying operation by the user's sliding of the shutter (13).

A band-like counter electrode (12) extending in a circumferential direction is provided between the top cover (11) and the designed cover (10a). The counter electrode (12) is for generating an electric field between a discharge end (72c) of the nozzle (72) and the counter electrode (12). The electrostatic sprayer (1) of the present embodiment forms a liquid ligament by squeezing, like a thread, the liquid discharged from the discharge end (72c) of the nozzle (72), using an electric field generated due to a potential difference between the charged liquid at the discharge end (72c) of the nozzle (72) and the counter electrode (12).

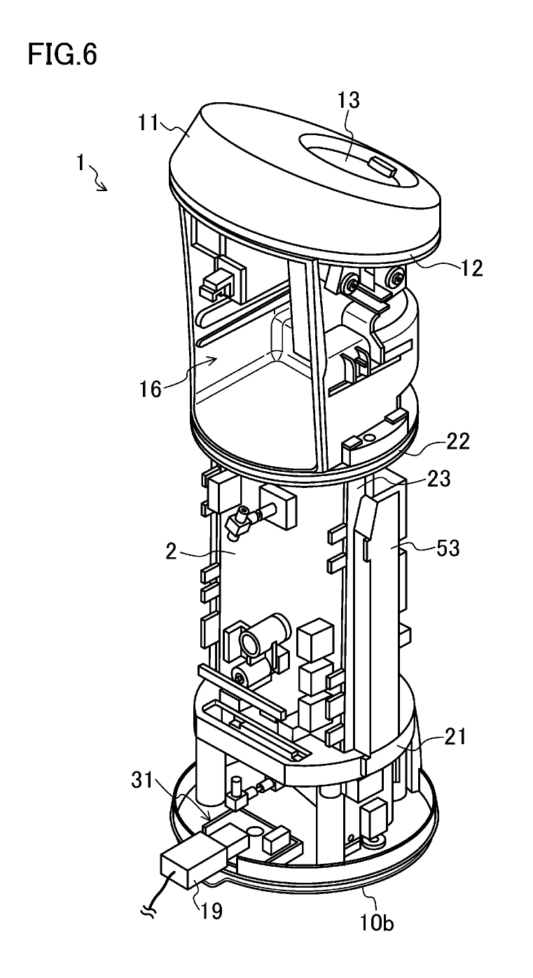

As shown in FIG. 6, the back side of the designed cover (10a) is provided with a backside opening (16) for attaching the spray cartridge (70) at a height corresponding to an upper machinery space (28). The backside opening (16) is in an approximately rectangular shape. A rear cover (17) which can be freely attached to and detached from the backside opening (16) is attached to the edge portion of the backside opening (16).

The casing (10) includes a lower base (21), an upper base (22), and a partition plate (23) inside the casing. The lower base (21) is located closer to the bottom in the casing (10). The upper base (22) is located approximately in the middle of the casing (10) in the longitudinal direction. Each of the bases (21, 22) extends horizontally to separate the interior of the casing (10) into upper and lower spaces. The partition plate (23) is provided between the lower base (21) and the upper base (22) to separate the interior of the casing (10) between the lower base (21) and the upper base (22) into front and rear spaces.

A central machinery space (24) is provided between the lower base (21) and the upper base (22). The central machinery space (24) is separated by the partition plate (23) into a first central machinery space (25) on the front side and a second central machinery space (26) on the back side. Further, a lower machinery space (27) is provided under the lower base (21), and the upper machinery space (28) is provided above the upper base (22).

The lower machinery space (27) accommodates a temperature-humidity sensor (29), a human detection sensor (30), and a USB board (31).

The temperature-humidity sensor (29) detects the temperature and the humidity of the room where the electrostatic sprayer (1) is placed. The temperature-humidity sensor (29) is connected to a controller (2) described later. Data of the temperature and humidity is sent to the controller (2) when detected.

The human detection sensor (30) is for detecting the presence or absence of a user as an object of the electrostatic sprayer (1). The human detection sensor (30) is configured to be a pyroelectric infrared sensor, for example. The human detection sensor (30) is housed in the lower machinery space (27) on the front side. The human detection sensor (30) is positioned such that its sensor surface faces obliquely upward to the front side through an opening in the casing (10). A lower half of the sensor surface of the human detection sensor (30) is covered by a mask member. Thus, the detection area is limited to an upper portion of the front side of the electrostatic sprayer (1), and therefore, it is possible to increase the accuracy in detecting the presence or absence of a human. The human detection sensor (30) is connected to the controller (2) described later. The data is sent to the controller (2) when detected.

The USB board (31) is a board to which a connector (19) of a universal serial bus (USB, the same hereinafter) is inserted. The USB board (31) is located at the bottom of the lower machinery space (27). The USB board (31) includes a connecting portion (32) to which the USB connector (19) is connected.

The electrostatic sprayer (1) according to the present embodiment converts the alternating voltage of 100 V supplied from a household alternating power supply (i.e., a household wall socket) to a direct voltage of 5 V, using the adapter (18), and this direct voltage is used as a power supply for the transfer unit (40) and the high voltage power supply (50). Specifically, the adapter (18) and the electrostatic sprayer (1) are connected together by inserting the USB connector (19) in the connecting portion (32) through USB cable. The power supply for the electrostatic sprayer (1) is not limited to the adapter (18), but USBs of personal computers and in-vehicle cigarette sockets, for example, may be used as a power supply.

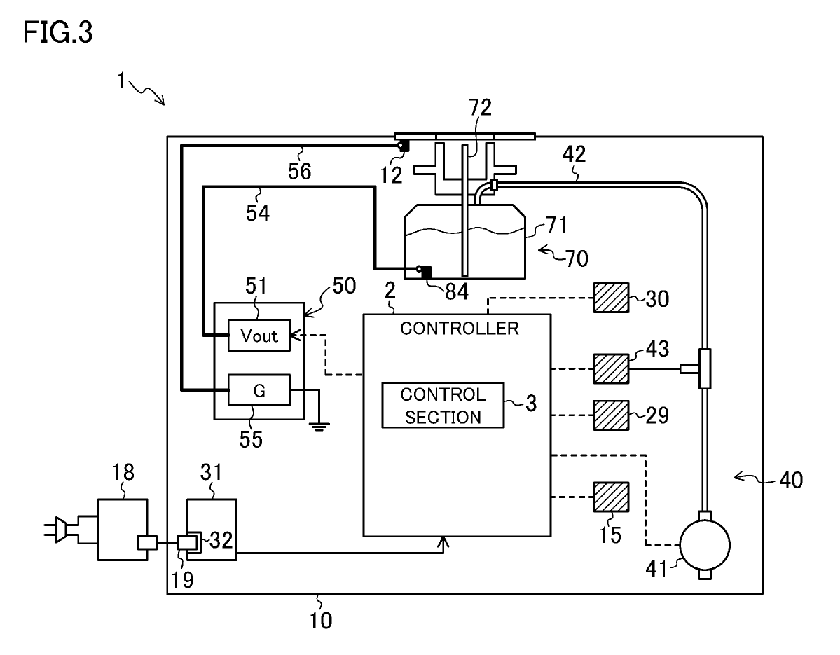

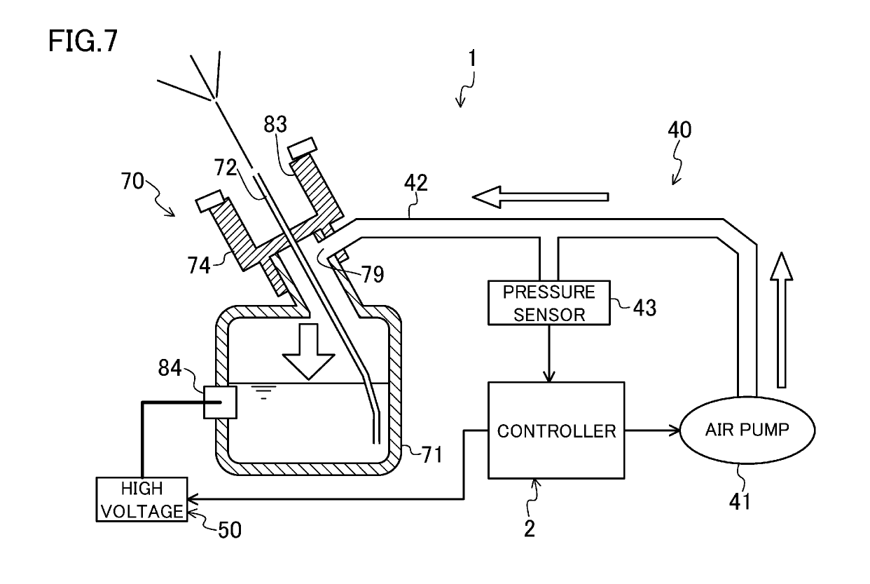

The transfer unit (40) includes a pressure pump (a transfer section) (41), a pressure sensor (43), and an air pipe (42) as shown in FIG. 3 and FIG. 7.

The pressure pump (41) supplies air into a tank (a container) (71) of the spray cartridge (70), thereby increasing a pressure of the liquid in the tank (71) and transferring the liquid from the tank (71) to the discharge end (72c) of the nozzle (72). The pressure pump (41) is of a diaphragm type, and is accommodated in the lower machinery space (27). In the lower machinery space (27), the pressure pump (41) is secured to a lower portion of the lower base (21) by a pump holder (not shown).

An air inlet of the pressure pump (41) is open outside the pressure pump (41), and an air outlet of the pressure pump (41) communicates one end of the air pipe (42). When the pressure pump (41) starts to operate, the air sucked through the air inlet of the pressure pump (41) is supplied to the tank (71) through the air pipe (42), and the pressure in the tank (71) increases. When the pressure pump (41) stops to operate, the air in the tank (71) returns to the pressure pump (41) through the air pipe (42), and the returned air is emitted outside through the pressure pump (41). As a result, the pressure in the tank (71) gradually decreases to atmospheric pressure.

The air pipe (42) is for sending the air in the pressure pump (41) into the tank (71). The air pipe (42) is configured to be a tube which extends from the lower machinery space (27) to the upper machinery space (28). As described above, one end of the air pipe (42) is connected to the pressure pump (41). The other end of the air pipe (42) is connected to an inlet (79) of the tank (71).

The pressure sensor (43) is for detecting a pressure in the tank (71). The pressure sensor (43) is provided on a control board (61) described later. A pressure detection opening of the pressure sensor (43) is open in a middle of the air pipe (42). The pressure sensor (43) is connected to a controller (2) described later. Data of the pressure is sent to the controller (2) when detected.

The high voltage power supply (50) is for applying a positive or negative high voltage to the liquid in the tank (71) through an electrode member (84), as shown in FIG. 3. The high voltage power supply (50) includes an output (51) and a ground section (55).

The output (51) is for increasing the pressure (+5 V) supplied from the adapter (18) to a high voltage and outputting the high voltage. The output (51) is configured by including electronic equipment, such as a transistor (not shown), a transformer, and a diode, on a board (52) accommodated in the first central machinery space (25). The output (51) increases the voltage (+5 V) supplied from the adapter (18) to a high voltage in a range of between +3 kV and +5 kV, or between −4 kV and −7 kV. The output (51) is configured such that one end of a high voltage line (54) is connected to an output terminal of the output (51), and that the high voltage is applied to the liquid in the tank (71) through the high voltage line (54) and the electrode member (84). The output (51) is configured to be capable of switching the polarity of the voltage to be output. The ground section (55) is grounded to form a ground with respect to the output (51). The ground section (55) is connected to the counter electrode (12) through a ground line (56).

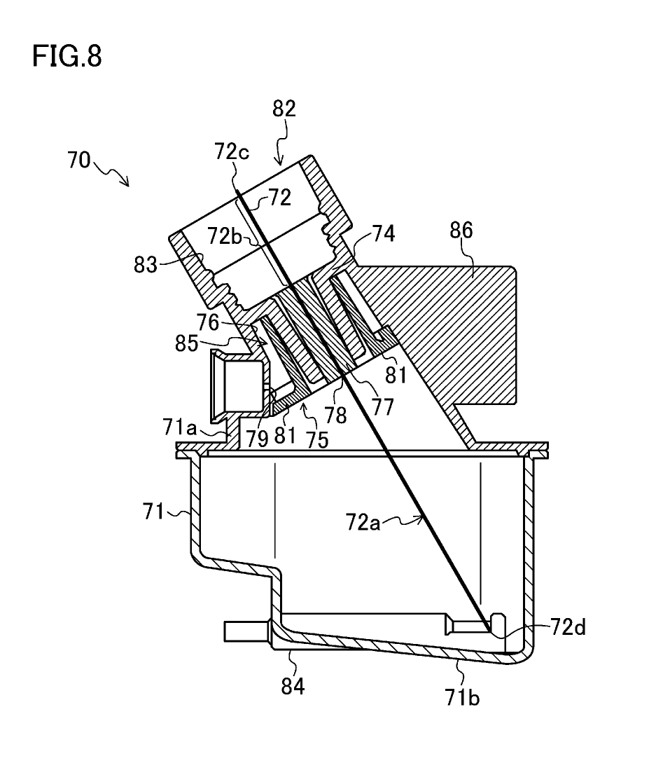

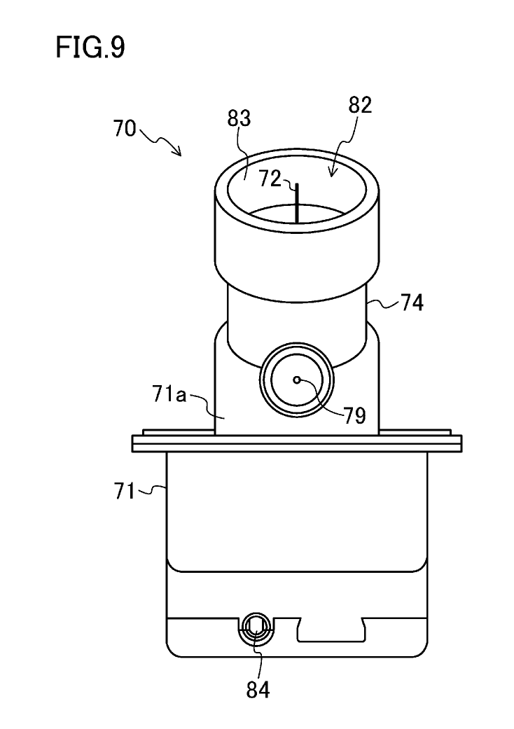

The spray cartridge (70) is for charging and spraying the stored liquid as shown in FIG. 8 and FIG. 9. The spray cartridge (70) is comprised of the tank (71), the electrode member (84), the nozzle (72), a nozzle base (74), and a handle (86). All of these components are integrally formed (i.e., cannot be separated from one another). That is, when the amount of liquid in the tank (71) becomes small, or when the liquid is used up, all the components are replaced at the same time.

The tank (71) is a container for storing the liquid inside. Specifically, the tank (71) is formed into a housing in an approximately rectangular shape, and forms a lower portion of the spray cartridge (70). The bottom of the tank (71) is formed into a bottom plate (71b) tilted downward to the back side, and therefore, the tank (71) has a deepest portion on the back side. Thus, even if the casing (10) falls down, the liquid in the tank (71) gathers in the deepest portion again.

The nozzle base (74) is a member for holding the nozzle (72). The nozzle base (74) is in an approximately cylindrical shape, and is integrally formed with the tank (71) via a neck member (71a) of the tank (71). The nozzle base (74) has an internal recess (75) and an external recess (82).

The internal recess (75) is formed in the internal end of the nozzle base (74). The internal recess (75) includes, at the center of the bottom, a holding portion (77) which protrudes in an axial direction toward the inner side. The holding portion (77) is provided with a through hole (78) in which the nozzle (72) is inserted. A member (81) is attached to around the holding portion (77). The member (81) is for filling part of a gap (85) between an inner wall (76) of the internal recess (75) and the holding portion (77). Filling part of the gap (85) with the member (81) prevents the liquid in the tank (71) from entering into the gap (85). The inner wall (76) of the internal recess (75) is provided with an inlet (79) to which the other end of the air pipe (42) is connected.

The external recess (82) is formed in the external end of the nozzle base (74). An inner wall (83) of the external recess (82) is configured to cover an exposed portion (72b) of the nozzle (72). The bottom of the external recess (82) is provided with an opening which communicates with the through hole (78).

The external recess (82) is configured such that the inner wall (83) is apart from the discharge end (72c) of the nozzle (72) by a predetermined distance, thereby forming air space around the exposed portion (72b) of the nozzle (72). The air space serves as an insulating material, and thus, a stable electric field is formed at the discharge end (72c) of the nozzle (72). The discharge end (72c) of the nozzle (72) is configured to protrude from the edge of the inner wall (83) of the external recess (82).

The nozzle (72) is made of a flexible resin, and in a narrow tube-like shape. The nozzle (72) has an outer diameter of between 0.3 mm and 0.4 mm, and an inner diameter of between 0.1 mm and 0.2 mm. The nozzle (72) is attached by being inserted in the through hole (78) of the nozzle base (74). The tip of the nozzle (72) protrudes from the edge of the inner wall (83) of the external recess (82) and is open to the outside, while the base end side (72a) of the nozzle (72) extends to a region near the deepest portion in the tank (71) and communicates with the liquid. The base end side (72a) of the nozzle (72) forms a nozzle extension portion according to the present invention. Since an intake end (72d) of the nozzle (72) extends to the deepest portion in the tank (71), all the liquid in the tank (71) can be used.

The electrode member (84) is a rod-like member made of a metal. One end of the electrode member (84) is inserted in the bottom portion of the tank (71) and is immersed in the liquid. The other end of the electrode member (84) extends to and is located at the outside of the tank (71), and is connected to one end of the high voltage line (54). That is, the electrode member (84) is electrically connected to the output (51) of the high voltage power supply (50) and is configured to apply a high voltage to the liquid in the tank (71).

As described above, the spray cartridge (70) transfers the liquid in the tank (71) to the nozzle (72) using the air from the pressure pump (41), and applies a high voltage to the liquid in the tank (71) to generate an electric field at the discharge end (72c) of the nozzle (72), thereby continuously atomizing the liquid from the discharge end (72c) of the nozzle (72).

The spray cartridge (70) is replaced when the liquid in the tank (71) is used up, or becomes small in amount. To remove the spray cartridge (70), the electrostatic sprayer (1) is stopped, and the rear cover (17) is detached from the casing (10), and the spray cartridge (70) is removed together with a cartridge holder (70a). To attach the spray cartridge (70) to the casing (10), the spray cartridge (70) attached to the cartridge holder (70a) is inserted in the upper machinery space (28) from the backside opening (16).

### Controller

The controller (2) controls the operation of the electrostatic sprayer (1) as shown in FIG. 3. The operation includes control of the pressure pump (41) and the high voltage power supply (50). The control will be described in detailed later.

The controller (2) includes a control section (3) which controls the operations of the pressure pump (41) and the high voltage power supply (50), on the control board (61) accommodated in the second central machinery space (26). The pressure sensor (43), the human detection sensor (30), the temperature-humidity sensor (29), and the operation switch (15) are connected to the controller (2).

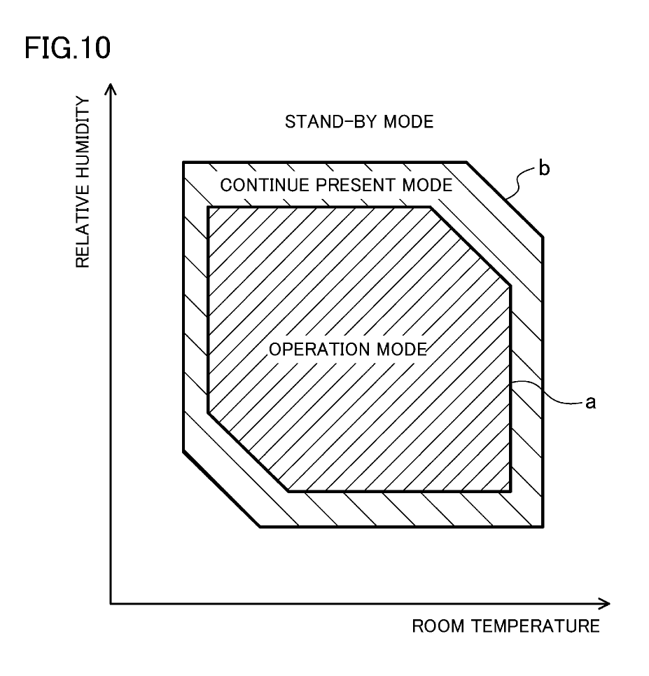

The control section (3) adjusts the spray amount of the electrostatic sprayer (1) based on a value detected by the temperature-humidity sensor (29). Specifically, the control section (3) switches between an operation mode and a stand-by mode of the electrostatic sprayer (1) according to the value detected by the temperature-humidity sensor (29). In the operation mode, the control section (3) starts the operations of the pressure pump (41) and the high voltage power supply (50). In the stand-by mode, the control section (3) stops the pressure pump (41) and the high voltage power supply (50). FIG. 10 shows a graph indicating a relationship between values detected by the temperature-humidity sensor (29) and each of the modes.

The range of the operation mode is set to a range where the user is expected to feel comfortable under the temperature and humidity conditions. The range outside the operation mode is the stand-by mode. The range of the stand-by mode represents the condition in which the user is expected to feel uncomfortable. The range of the stand-by mode includes a range which represents relatively high temperature and high humidity, and a range which represents a relatively low temperature and low humidity. For example, the high temperature and high humidity condition is in a range where the humidity is 82% or more and the temperature is 30° C. or more. The low temperature and low humidity condition is in a range where the humidity is 20% or less and the temperature is 8° C. or less.

As shown in FIG. 10, there is a range between the operation mode range and the stand-by mode range, in which range the present mode is continued. The border at a time when the operation is changed from the stand-by mode to the operation mode is the first border (a). The border at a time when the operation is changed from the operation mode to the stand-by mode is the second border (b).

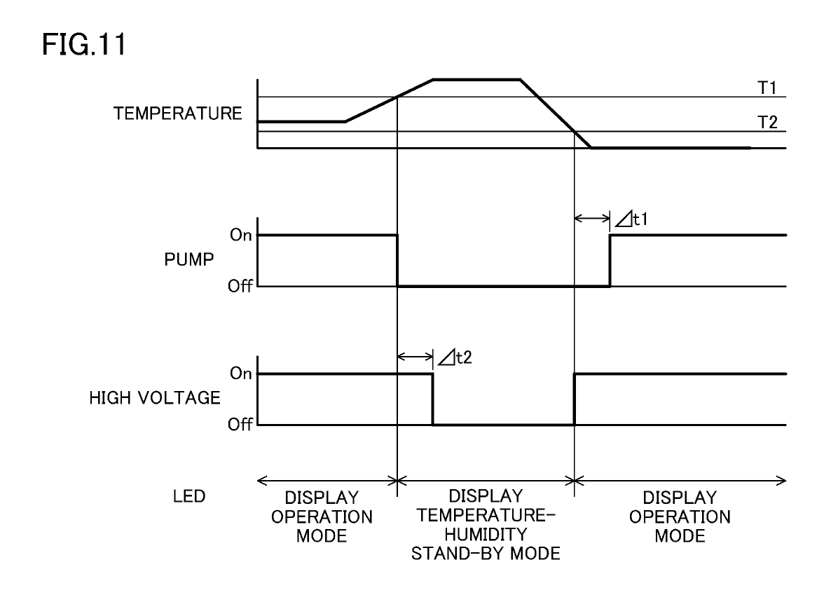

When the operation mode is changed to the stand-by mode, the control section (3) stops the operation of the pressure pump (41), and then stops the operation of the high voltage power supply (50) after a predetermined time (Δt2) has passed, as shown in FIG. 11. When the stand-by mode is changed to the operation mode, the control section (3) starts the operation of the high voltage power supply (50), and then starts the operation of the pressure pump (41) after a predetermined time (Δt1) has passed. It is thus possible to prevent the liquid from being transferred to the discharge end (72c) of the nozzle (72) without an electric field generated at the discharge end (72c) of the nozzle (72). As a result, a leak of the liquid from the discharge end (72c) of the nozzle (72) can be prevented. The casing (10) is provided, on its outer surface, with a light emitting diode (LED, same hereinafter) which notifies that the present mode is the operation mode or the stand-by mode. The LED enables the user to know in which mode the sprayer is operating.

In the operation mode, the control section (3) adjusts a voltage V applied from the high voltage power supply (50), based on a humidity value M detected by the temperature-humidity sensor (29), thereby making it possible to stabilize the state of spraying the liquid from the nozzle (72) like a thread. Specifically, the control section (3) reduces the voltage V applied from the high voltage power supply (50) when the humidity of the space where the user is present increases, and increases the voltage V when the humidity of the space decreases.

When the humidity increases, the potential of the casing (10) which provides insulation between the liquid in the tank (71) and the counter electrode (12) decreases. If the potential of the casing (10) decreases, the voltage V needs to be reduced, otherwise an excessive voltage may be applied and the liquid may not be easily sprayed like a thread from the nozzle (72).

On the other hand, the potential of the casing (10) increases when the humidity decreases. Thus, the voltage V needs to be increased, otherwise undervoltage may occur and the liquid may not be easily sprayed like a thread from the nozzle (72).

### Operation Mechanism

### Operation of Electrostatic Sprayer

An operation of the electrostatic sprayer (1) of the present embodiment will be described. In the electrostatic sprayer (1), the liquid is sprayed as a liquid ligament, separated into droplets, and diffused to reach the user. The electrostatic sprayer (1) is capable of operation when the spray cartridge (70) is placed in the casing (10).

First, the user opens the shutter (13) by sliding it by hand toward the back surface of the casing (10), when the shutter (13) pushes the operation switch (15) and turns the operation switch (15) ON. When the operation switch (15) is turned ON, the controller (2) drives the pressure pump (41). The pressure pump (41) introduces air into the tank (71) through the air pipe (42). The air pressure is increased in the tank (71). The liquid in the tank (71) is pushed by the air and flows into the nozzle (72) through the intake end (72d) of the nozzle (72). The liquid having flowed into the nozzle (72) is transferred to the discharge end (72c) of the nozzle (72).

Further, when the operation switch (15) is turned ON, a voltage adjustment section (6) of the controller (2) outputs a high voltage from the output (51) of the high voltage power supply (50). The high voltage is applied to the liquid in the tank (71) via the electrode member (84).

A potential difference is generated between the charged liquid and the counter electrode (12), and an electric field is generated at the discharge end (72c) of the nozzle (72). The liquid at the discharge end (72c) of the nozzle (72) is pulled by the electric field and is sprayed as a liquid ligament, and thereafter separated into droplets of a size of about from several tens of micrometers (μm) to 300 μm. Since the liquid is charged, the separation causes repulsion between the droplets, and thus, the droplets diffuse. The diffused droplets are scattered toward the user as a ground, and adhere to the user's face.

Even when the operation switch (15) is ON, the controller (2) can control the spraying operation based on data detected by the human detection sensor (30). Specifically, if the human detection sensor (30) detects the absence of the user, the controller (2) stops an output of the high voltage from the voltage adjustment section (6), and stops the operation of the pressure pump (41). If the human detection sensor (30) detects the presence of the user again, the controller (2) starts the output of the high voltage from the voltage adjustment section (6), and starts the operation of the pressure pump (41). Thus, it is possible to reliably prevent the liquid from being wastefully sprayed without the user.

### Operational Control of Control Section

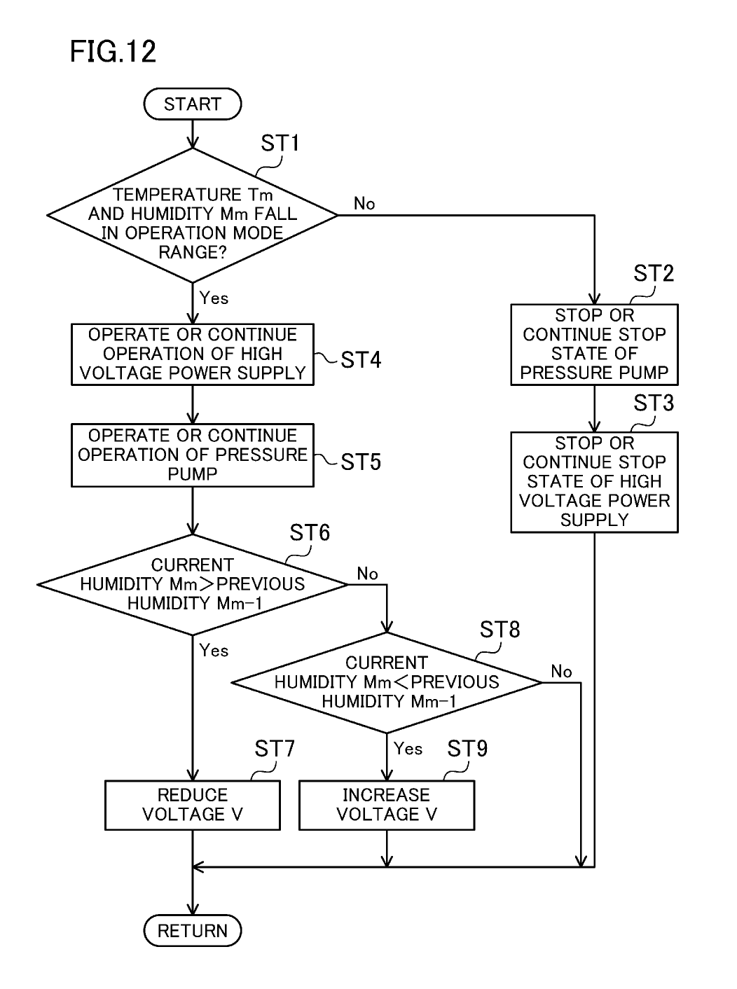

A control operation of the control section (3) will be described. FIG. 12 shows a flow chart of the control operation. The control operation is performed from after the user's turning on of the operation switch (15) until turning off of the operation switch (15).

First, in step ST1, it is decided whether or not a temperature value Tm and a humidity value Mm of the present time which are input from the temperature-humidity sensor (29) are within the range of the operation mode shown in FIG. 10. If the temperature value Tm and the humidity value Mm of the present time are within the range of the operation mode, it is decided that the user is in a comfortable state under the temperature-humidity conditions and the process goes to step ST4. If not, it is decided that the user is in an uncomfortable state under the temperature-humidity conditions, and the process goes to step ST2.

In step ST2, if the operation of the pressure pump (41) is stopped, the stop state is continued. If the pressure pump (41) is in operation, the operation of the pressure pump (41) is stopped. Then, the process moves from step ST2 to step ST3. In step ST3, if the operation of the high voltage power supply (50) is stopped, the stop state is continued. If the high voltage power supply (50) is in operation, the operation of the high voltage power supply (50) is stopped. A leak of the liquid from the discharge end (72c) of the nozzle (72) is prevented by stopping the pressure pump (41) first, and thereafter stopping the high voltage power supply (50) as described above. After the completion of step ST3, the process returns to step ST1 again.

In step ST4, on the other hand, if the operation of the high voltage power supply (50) is stopped, the high voltage power supply (50) is actuated. If the high voltage power supply (50) is in operation, the operation of the high voltage power supply (50) is continued. Then, the process moves from the step ST4 to step ST5. In step ST5, if the operation of the pressure pump (41) is stopped, the pressure pump (41) is actuated. If the pressure pump (41) is in operation, the operation of the pressure pump (41) is continued. A leak of the liquid from the discharge end (72c) of the nozzle (72) is prevented by actuating the high voltage power supply (50) first, and thereafter actuating the pressure pump (41) as described above. After the completion of step ST5, the process goes to step ST6.

In step ST6, it is decided whether or not the humidity value Mm input from the temperature-humidity sensor (29) is larger than the humidity value M(m−1) input at the previous time. If the humidity value Mm is larger than the humidity value M(m−1) input at the previous time, the process goes to step ST7, and if not, the process goes to step ST8.

In step ST7, the voltage V applied from the high voltage power supply (50) is reduced by a predetermined amount. As a result, as mentioned above, it is possible to stabilize the state of spraying the liquid from the discharge end (72c) of the nozzle (72). Then, after the completion of step ST7, the process returns to step ST1 again.

In step ST8, on the other hand, it is decided whether or not the humidity value Mm input from the temperature-humidity sensor (29) is smaller than the humidity value M(m−1) input at the previous time. If the humidity value Mm is smaller than the humidity value M(m−1) input at the previous time, the process goes to step ST9, and if not, the process returns to step ST1 again. Here, the process returns to step ST1 from step ST8 only when the humidity value Mm input from the temperature-humidity sensor (29) does not change.

In step ST9, the voltage V applied from the high voltage power supply (50) is increased by a predetermined amount. As a result, as mentioned above, it is possible to stabilize the state of spraying the liquid from the discharge end (72c) of the nozzle (72). Then, after the completion of step ST9, the process returns to step ST1 again. These processes are successively performed until the operation switch (15) is turned off.

### Advantages of Embodiment

In the present embodiment, the spray amount of the electrostatic sprayer (1) can be adjusted based on the value detected by the temperature-humidity sensor (29). Thus, the spray amount can be optimized and saved, according to the space where the user is present. As a result, it is possible to delay the time when the tank (71) becomes empty, and reduce the number of maintenance procedures for preventing the tank (71) from becoming empty.

In the present embodiment, liquid spraying of the electrostatic sprayer (1) is stopped if it is decided that the space where the user is present is in an uncomfortable state, because in such a state the user may not be able to easily feel the effect of the liquid spraying. Thus, wasteful spraying of the liquid is reduced, and the number of maintenance procedures can also be reduced than before. Due to the reduction in the number of maintenance procedures, the user can use the electrostatic sprayer (1) comfortably.

In the present embodiment, it is possible to prevent the liquid from being transferred to the discharge end (72c) of the nozzle (72) without an electric field generated at the discharge end (72c) of the nozzle (72). As a result, a leak of the liquid from the discharge end (72c) of the nozzle (72) can be prevented.

In the present embodiment, liquid spraying of the electrostatic sprayer (1) is started if it is decided that the space where the user is present is in a comfortable state, because in such a state the user can easily feel the effect of the liquid spraying. Thus, the electrostatic sprayer (1) can be effectively operated.

In the present embodiment, if the humidity of the space where the user is present is high, the voltage V applied from the high voltage power supply (50) is reduced so that the liquid can be easily sprayed like a thread from the nozzle (72). Thus, the state of spraying the liquid from the electrostatic sprayer (1) can be stabilized even if the humidity of the space where the user is present is increased.

In the present embodiment, if the humidity of the space where the user is present is low, the voltage V applied from the high voltage power supply (50) is increased so that the liquid can be easily sprayed like a thread from the nozzle (72). Thus, the state of spraying the liquid from the electrostatic sprayer (1) can be stabilized even if the humidity of the space where the user is present is reduced.

### First Variation of Embodiment

In the present variation, the configuration of the control section (3) in the electrostatic sprayer (1) according to the above embodiment is changed.

Although not shown, a control section (3) according to the present variation includes a reception section, a memory section, a spray amount setting section, a process section, and a transmit section.

The reception section is connected to the temperature-humidity sensor (29) via a communication cable, and receives a temperature measured by the temperature-humidity sensor (29).

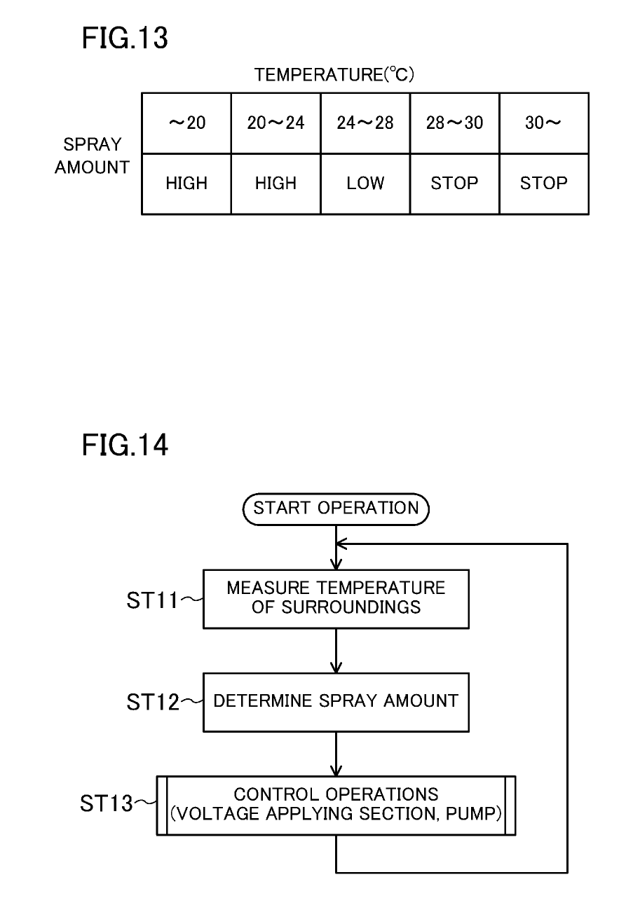

The memory section stores a correspondence relationship between a temperature of the surroundings (the space where the user is present) and a spray amount. The spray amount as used in the correspondence relationship is an amount which needs to be sprayed for skin moisturization, and is estimated from a dry skin condition at each temperature. That is, the memory section is configured to be capable of deriving a spray amount suitable for skin moisturization by making reference to the correspondence relationship. The correspondence relationship is stored in the memory section as a table or a function. For example, in the table shown in FIG. 13, spray amounts necessary for skin moisturization are grouped into three types (“high,” “low” and “stop”) so as to correspond to a plurality of different temperature ranges.

The spray amount setting section is configured to categorize the temperatures received in the reception section based on the correspondence relationship stored in the memory section, and determine a necessary spray amount according to the correspondence relationship. The spray amount setting section changes the determined spray amount value every time the measured temperature varies.

The process section calculates a signal which adjusts the voltage of the high voltage power supply (50) and the pressure (i.e., a transfer amount) of the pressure pump (41) so that the amount determined by the spray amount setting section will be sprayed. The signal is calculated according to a function or a table which specifies a relationship between a spray amount and a voltage or a pressure.

The transmit section is connected to each of the high voltage power supply (50) and the pressure pump (41) via a communication cable, and transmits the signal calculated in the process section to the high voltage power supply (50) and the pressure pump (41). When the signal is input to the high voltage power supply (50) and the pressure pump (41), a voltage and a pressure corresponding to the signal are output. As a result, the nozzle (72) sprays an amount determined by the spray amount setting section.

As described above, in the control section (3), the spray amount setting section determines a spray amount according to the temperature of the surroundings which is received by the reception section, and the voltage of the high voltage power supply (50) and the pressure of the pressure pump (41) are changed so that the determined amount will be sprayed. In the electrostatic sprayer (1) of the present invention, the voltage of the high voltage power supply (50) and the pressure of the pressure pump (41) are increased or decreased, thereby adjusting the spray amount corresponding to the temperature of the surroundings.

The operation of the control section (3) will be specifically described. As shown in FIG. 14, a temperature of the surroundings where the liquid is sprayed is measured in step ST11. The temperature is measured by the temperature-humidity sensor (29), and the reception section receives the measured temperatures at predetermined intervals.

Next, a spray amount is determined in step ST12. When the measured temperature is received in step ST11, the spray amount setting section determines a spray amount suitable for skin moisturization. The spray amount suitable for skin moisturization is determined according to the correspondence relationship between a temperature and a spray amount stored in the memory section. The spray amount is determined by having the measured temperature referred to a table or a function representing the correspondence relationship. Specifically, skin is presumed to be moist enough from a lot of sweat in the environment where the temperature is relatively high, e.g., 28° C. or more. In such a case, spraying is not needed to moisturize the skin. Thus, as shown in FIG. 13, it is decided to stop spraying based on the table. On the other hand, skin is presumed to be dry with almost no sweating in the environment where the temperature is low. In such a case, much liquid needs to be sprayed to moisturize the skin. Thus, the spray amount is set to “high” based on the table.

Next, in step ST13, the operations of the high voltage power supply (50) and the pressure pump (41) are controlled. First, the process section calculates a signal which adjusts the voltage of the high voltage power supply (50) and the pressure of the pressure pump (41) so that the amount determined in step ST12 will be sprayed. After the calculation of the signal, the signal is input to the high voltage power supply (50) and the pressure pump (41), and a voltage and a pressure corresponding to the signal are respectively output. The spray amount is controlled so that a determined amount is sprayed, by increasing and decreasing the voltage of the high voltage power supply (50) and the pressure of the pressure pump (41). For example, the high voltage power supply (50) and the pressure pump (41) are controlled such that the voltage and the pressure are increased in the case where the spray amount needs to be increased, and such that the voltage and the pressure are decreased in the case where the spray amount needs to be reduced.

That is, in the electrostatic sprayer (1), if the pressure (a transfer amount) of the pressure pump (41) is increased, the capability of supplying the liquid to the tip of the nozzle (72) is increased, and the liquid spray amount is accordingly increased. Further, if the voltage of the high voltage power supply (50) is increased, a potential difference between the charged liquid and the counter electrode (12) are increased and the electrostatic force applied to the charged liquid increases. Accordingly, the liquid spray amount is increased. That is, in the electrostatic sprayer (1), the liquid spray amount can be changed by changing at least one of the voltage of the high voltage power supply (50) or the pressure (a transfer amount) of the pressure pump (41).

The control section (3) repeatedly performs processes of from step ST11 to step ST13 while the liquid is continuously sprayed.

As described above, in the electrostatic sprayer (1) of the present variation, a spray amount suitable for skin moisturization is determined according to a measured temperature of the surroundings (i.e., a temperature of the space where the user is present). Further, the spray amount is adjusted by controlling the operations of the high voltage power supply (50) and the pressure pump (41) such that the determined amount is sprayed. Thus, in the electrostatic sprayer (1) according to the present variation, it is possible to control skin moisturization according to the temperature of the surroundings.

In the present variation, as well, the spray amount is adjusted according to the value detected by the temperature-humidity sensor (29). Thus, it is possible to optimize and save the spray amount according to the space where the user is present. As a result, it is possible to delay the time when the tank (71) becomes empty, and reduce the number of maintenance procedures for preventing the tank (71) from becoming empty.

The control of the spray amount by the control section (3) is not limited to control using both of the high voltage power supply (50) and the pressure pump (41), but similar effects can be obtained by, for example, making the pressure of the pressure pump (41) constant, and increasing and decreasing only the voltage of the high voltage power supply (50).

### Second Variation of Embodiment

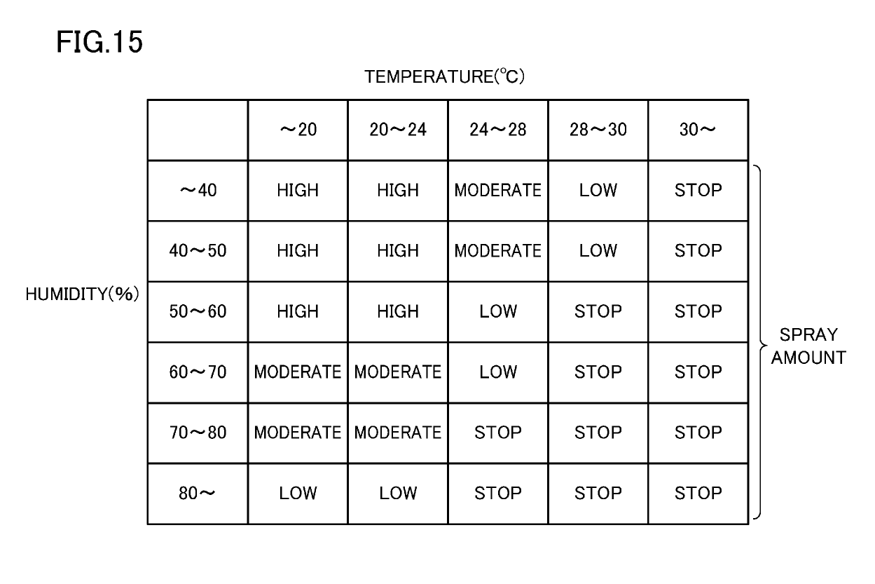

In the present variation, the table described in the first variation is changed as shown in FIG. 15. In the first variation, the temperature of the surroundings is measured, and a spray amount is determined based on the table which specifies a correspondence relationship between the temperatures and the spray amount. On the other hand, in the present variation, the temperature and humidity of the surroundings (i.e., the temperature and humidity of the space where the user is present) are measured, and a spray amount is determined based on a table which specifies a correspondence relationship between the temperature and humidity and the spray amount.

In a control section (3) of the present variation, a reception section is configured to receive both of the temperature and the humidity measured by the temperature-humidity sensor (29). When the results of measurement of the temperature and the humidity are received, the spray amount setting section determines a spray amount necessary for skin moisturization based on the table shown in FIG. 15, for example. In the table shown in FIG. 15, spray amounts suitable for skin moisturization are grouped into four types (“high,” “moderate,” “low” and “stop”) so as to correspond to different temperature ranges and humidity ranges. If the spray amount is determined based on this table, the voltage of the high voltage power supply (50) and the pressure (i.e., the transfer amount) of the pressure pump (41) are controlled such that the determined amount of liquid is sprayed similar to the first variation. For example, in the high humidity environment where the humidity is 80% or more, skin is presumed to be relatively moist due to moisture even if the temperature is low.

In such a case, spraying for skin moisturization is not necessary or a small amount of spray is enough. Thus, as shown in FIG. 15, it is determined to stop spraying or the spray amount is set to “low” based on the table. On the other hand, in the environment where the humidity is low, skin is presumed to be dry even if the temperature is relatively high. In such a case, the spray amount is determined to be relatively large according to the table, and based on this table, the spray amount is decided.

In the present variation, the humidity is added as a setting condition of the spray amount. By including, as a setting condition, the humidity which affects dry skin next to the temperature, it is possible to determine the spray amount necessary for skin moisturization in more detail, and control skin moisture with more accuracy. Thus, the spray amount can be further optimized and saved according to the space where the user is present. As a result, it is possible to further delay the time when the tank (71) becomes empty.

### Other Embodiments

The above embodiment may include the following configurations.

In the above embodiment, the temperature-humidity sensor (29) is used to decide the mode, i.e., the operation mode or the stand-by mode. However, the configuration is not limited to the temperature-humidity sensor (29). For example, a temperature sensor or a humidity sensor may be provided to decide the mode instead of using the temperature-humidity sensor (29).

If only the temperature sensor is provided, the range of the operation mode is set to a range where the user is expected to feel comfortable under the temperature condition. If only the humidity sensor is provided, the range of the operation mode is set to a range where the user is expected to feel comfortable under the humidity condition.

In the above embodiment, the range of the operation mode of the control section (3) is set to a range where the user is expected to feel comfortable under the temperature and humidity conditions, but does not need to be limited to this configuration. For example, since the state of liquid spraying is easily affected by the temperature and the humidity of the space where the user is present, the range of the operation mode may be set to a range in which the state of liquid spraying is stable under the temperature-humidity conditions. In this case, the stand-by mode falls in a range in which the state of liquid spraying is unstable. Thus, similar to the present invention, wasteful spraying of the liquid is reduced, and the number of maintenance procedures to avoid an empty tank can also be reduced than before.

The above embodiment may include a manual adjustment section for adjusting the liquid spray amount manually. In such a case, an automatic operation in which the liquid spray amount is adjusted using the control section (3) described above, and a manual operation in which the liquid spray amount is adjusted using the manual adjustment section can be switched.

The foregoing embodiments are merely preferred examples in nature, and are not intended to limit the scope, applications, and use of the invention.

### INDUSTRIAL APPLICABILITY

As described above, the present invention relates to electrostatic sprayers, and is specifically useful in controlling operation of the electrostatic sprayers.

### DESCRIPTION OF REFERENCE CHARACTERS

1 electrostatic sprayer

2 controller

3 control section

10 casing

12 counter electrode

29 temperature-humidity sensor

40 transfer unit

41 pressure pump (transfer section)

43 pressure sensor

50 high voltage power supply (voltage applying section)

70 spray cartridge

71 tank (container)

72 nozzle

1. An electrostatic sprayer, comprising: a container which stores a liquid; a nozzle which connects an inside and an outside of the container; a transfer section which transfers the liquid in the container to a discharge end of the nozzle; a counter electrode located near the discharge end of the nozzle; and a voltage applying section which applies a voltage to the liquid in the container to generate an electric field between the liquid transferred to the discharge end of the nozzle by the transfer section and the counter electrode, for spraying the liquid flowing out of the discharge end of the nozzle to a user, wherein
the electrostatic sprayer includes
a detecting section which detects at least a temperature of a space where the user is present, and
a control section which adjusts at least one of an amount of the liquid transferred by the transfer section or a voltage applied by the voltage applying section according to a value detected by the detecting section.

2. An electrostatic sprayer, comprising: a container which stores a liquid; a nozzle which connects an inside and an outside of the container; a transfer section which transfers the liquid in the container to a discharge end of the nozzle; a counter electrode located near the discharge end of the nozzle; and a voltage applying section which applies a voltage to the liquid in the container to generate an electric field between the liquid transferred to the discharge end of the nozzle by the transfer section and the counter electrode, for spraying the liquid flowing out of the discharge end of the nozzle to a user, wherein
the electrostatic sprayer includes
a detecting section which detects at least a humidity of a space where the user is present, and
a control section which adjusts at least one of an amount of the liquid transferred by the transfer section or a voltage applied by the voltage applying section according to a value detected by the detecting section.

3. The electrostatic sprayer of claim 1, wherein
the detecting section detects a temperature and a humidity of the space where the user is present.

4. The electrostatic sprayer of claim 1, wherein
the control section stops operations of the transfer section and the voltage applying section when the value detected by the detecting section is changed from a range where the user is expected to feel comfortable at least under a temperature condition to a range where the user is expected to feel uncomfortable at least under a temperature condition.

5. The electrostatic sprayer of claim 2, wherein
the control section stops operations of the transfer section and the voltage applying section when the value detected by the detecting section is changed from a range where the user is expected to feel comfortable at least under a humidity condition to a range where the user is expected to feel uncomfortable at least under a humidity condition.

6. The electrostatic sprayer of claim 4, wherein
the control section stops the operation of the transfer section, and thereafter stops the operation of the voltage applying section.

7. The electrostatic sprayer of claim 1, wherein
the control section starts operations of the transfer section and the voltage applying section when the value detected by the detecting section is changed from a range where the user is expected to feel uncomfortable at least under a temperature condition to a range where the user is expected to feel comfortable at least under a temperature condition.

8. The electrostatic sprayer of claim 2, wherein
the control section starts operations of the transfer section and the voltage applying section when the value detected by the detecting section is changed from a range where the user is expected to feel uncomfortable at least under a humidity condition to a range where the user is expected to feel comfortable at least under a humidity condition.

9. The electrostatic sprayer of claim 7, wherein
the control section starts the operation of the voltage applying section, and thereafter starts the operation of the transfer section.

10. The electrostatic sprayer of claim 2, wherein
the electrostatic sprayer includes an insulating material which provides insulation between the liquid in the container and the counter electrode,
the detecting section is a space facing the insulating material, and is configured to detect the humidity of the space where the user is present, and
the control section is configured to reduce the voltage applied by the voltage applying section when a humidity value as the value detected by the detecting section increases.

11. The electrostatic sprayer of claim 2, wherein
the electrostatic sprayer includes an insulating material which provides insulation between the liquid in the container and the counter electrode,
the detecting section is a space facing the insulating material, and is configured to detect the humidity of the space where the user is present, and
the control section is configured to increase the voltage applied by the voltage applying section when a humidity value as the value detected by the detecting section decreases.

12. The electrostatic sprayer of claim 1, wherein
the control section includes in advance a table or a function which specifies a correspondence relationship between the value detected by the detecting section and a spray amount of the liquid based on a dry skin condition, and adjusts at least one of the amount of the liquid transferred by the transfer section or the voltage applied by the voltage applying section according to the table or the function.

13. The electrostatic sprayer of claim 2, wherein
the detecting section detects a temperature and a humidity of the space where the user is present.

14. The electrostatic sprayer of claim 5, wherein
the control section stops the operation of the transfer section, and thereafter stops the operation of the voltage applying section.

15. The electrostatic sprayer of claim 8, wherein
the control section starts the operation of the voltage applying section, and thereafter starts the operation of the transfer section.

16. The electrostatic sprayer of claim 3, wherein
the control section includes in advance a table or a function which specifies a correspondence relationship between the value detected by the detecting section and a spray amount of the liquid based on a dry skin condition, and adjusts at least one of the amount of the liquid transferred by the transfer section or the voltage applied by the voltage applying section according to the table or the function.
